(19) United States
(12) Patent Application Publication
(10) Pub. No.: US 2026/0032515 A1
(43) Pub. Date: Jan. 29, 2026

(54) LINK MANAGEMENT TO IMPROVE THROUGHPUT AND OPERATION

(71) Applicant: QUALCOMM Incorporated, San Diego, CA (US)

(72) Inventors: Ruiqing YE, Alviso, CA (US); Gyanranjan HAZARIKA, Milpitas, CA (US); Sandip HOMCHAUDHURI, San Jose, CA (US); Simon Jan BRAND, Pleasanton, CA (US)

(21) Appl. No.: 18/782,007

(22) Filed: Jul. 23, 2024

(51) Int. Cl. H04W 28/08; H04W 28/02; H04W 28/082

(52) U.S. Cl. CPC H04W 28/0983; H04W 28/0268; H04W 28/082

(57) ABSTRACT

This disclosure provides methods, components, devices and systems for link management to improve throughput and operation. Some aspects more specifically relate to techniques for performing admission for clients, such as multi-link operation (MLO) clients, to one or more of a set of communication links of an access point (AP). In some aspects, the AP may initiate an admission control procedure to admit a client to a communication link. The AP may admit the client to a communication link based on a quantity of idle clients on the communication link being less than a threshold quantity of idle clients for the communication link. In some other implementations, the AP may allocate or reserve at least a portion of a link for different types of clients, such as priority clients, so that the AP may maintain high communications quality for an active priority client.

### TECHNICAL FIELD

This disclosure relates generally to wireless communication and, more specifically, to link management to improve throughput and operation.

### DESCRIPTION OF THE RELATED TECHNOLOGY

Wireless communication networks may include various types of wireless communication devices including network entities (such as wireless access points (AP) or base stations (BS)), client devices or clients (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communication by a wireless node is described. The method may include associating a first client with a set of multiple communication links, admitting the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total link capacity for the set of multiple communication links, and outputting a first frame for transmission to the first client via the first communication link, where the first frame indicates that the first client is allocated to the first communication link.

A wireless node for wireless communication is described. The wireless node may include a processing system that includes processor circuitry and memory circuitry that stores code. The processing system may be configured to cause the wireless node to associate a first client with a set of multiple communication links, admit the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total link capacity for the set of multiple communication links, and output a first frame for transmission to the first client via the first communication link, where the first frame indicates that the first client is allocated to the first communication link.

Another wireless node for wireless communication is described. The wireless node may include means for associating a first client with a set of multiple communication links, means for admitting the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total link capacity for the set of multiple communication links, and means for outputting a first frame for transmission to the first client via the first communication link, where the first frame indicates that the first client is allocated to the first communication link.

A non-transitory computer-readable medium storing code for wireless communication is described. The code may include instructions executable by one or more processors to associate a first client with a set of multiple communication links, admit the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total link capacity for the set of multiple communication links, and output a first frame for transmission to the first client via the first communication link, where the first frame indicates that the first client is allocated to the first communication link.

In some examples of the method, wireless nodes, and non-transitory computer-readable medium described herein, the threshold quantity of idle clients may be equal to the total quantity of idle clients multiplied by the ratio of the residual link capacity of the first communication link to the total link capacity for the set of multiple communication links.

Some examples of the method, wireless nodes, and non-transitory computer-readable medium described herein may further include operations, features, means, or instructions for evaluating each communication link of the set of multiple communication links that includes that first communication link to admit the first client in an order, the order being based on a capacity of each communication link relative to capacities of other communication links of the set of multiple communication links, where the admission may be based on the evaluation.

In some examples of the method, wireless nodes, and non-transitory computer-readable medium described herein, the order of evaluating the set of multiple communication links begins with an initial communication link with a highest relative link capacity and ends with a final communication link with a lowest relative link capacity.

In some examples of the method, wireless nodes, and non-transitory computer-readable medium described herein, the quantity of idle clients on the first communication link includes the quantity of idle clients on the first communication link at a time of the evaluation of the first communication link.

Some examples of the method, wireless nodes, and non-transitory computer-readable medium described herein may further include operations, features, means, or instructions for associating a second client with the set of multiple communication links and admitting the second client to a second communication link of the set of multiple communication links based on the quantity of idle clients on the first communication link being greater than or equal to a threshold quantity of idle clients for the first communication link, and the quantity of idle clients on the second communication link being less than the threshold quantity of idle clients for the second communication link.

In some examples of the method, wireless nodes, and non-transitory computer-readable medium described herein, admitting the second client to the second communication link may include operations, features, means, or instructions for evaluating whether to admit the first client to the first communication link if the quantity of idle clients on the first communication link may be less than the threshold quantity of idle clients for the first communication link, selecting the second communication link based on a failure to admit the second client on the first communication link, where the second communication link having a next highest link capacity relative to the first communication link, and admitting the second client to the second communication link based on the quantity of idle clients on the second communication link being less than a threshold quantity of idle clients for the second communication link.

Some examples of the method, wireless nodes, and non-transitory computer-readable medium described herein may further include operations, features, means, or instructions for associating each of a set of multiple clients to one of the set of multiple communication links, where the set of multiple clients include the first client and admitting the set of multiple clients to respective communication links in accordance with respective link capacities of the respective communication links.

In some examples of the method, wireless nodes, and non-transitory computer-readable medium described herein, admitting the set of multiple clients to the respective communication links may include operations, features, means, or instructions for admitting the set of multiple clients to the respective communication links based on the quantity of idle clients on a respective communication link being equal to the threshold quantity of idle clients for the respective communication link.

In some examples of the method, wireless nodes, and non-transitory computer-readable medium described herein, the admission of the set of multiple clients to the respective communication links begins with admission of the first client to the first communication link, the first communication link having a higher link capacity relative to other communication links of the set of multiple communication links.

Some examples of the method, wireless nodes, and non-transitory computer-readable medium described herein may further include operations, features, means, or instructions for provisioning the first client to either a second communication link or multiple communication links based on at least one of a congestion level of the first communication link and congestion levels of other links of the set of multiple communication links, a latency requirement of the first client communicating over the first communication link, or a level of interference experienced by the first communication link, or a collision rate on the first communication link.

Some examples of the method, wireless nodes, and non-transitory computer-readable medium described herein may further include operations, features, means, or instructions for generating the first frame indicating the first client may be allocated to the first communication link.

In some examples of the method, wireless nodes, and non-transitory computer-readable medium described herein, one or more transceivers may be configured to transmit the first frame, where the wireless nodes may be configured as an access point (AP).

A method for wireless communication by a wireless node is described. The method may include associating a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients and moving a non-priority client from a priority communication link to the one or more non-priority communication links based on the priority client failing to satisfy one or more performance guarantees on any of the set of multiple communication links.

A wireless node for wireless communication is described. The wireless node may include a processing system that includes processor circuitry and memory circuitry that stores code. The processing system may be configured to cause the wireless node to associate a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients and move a non-priority client from a priority communication link to the one or more non-priority communication links based on the priority client failing to satisfy one or more performance guarantees on any of the set of multiple communication links.

Another wireless node for wireless communication is described. The wireless node may include means for associating a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients and means for moving a non-priority client from a priority communication link to the one or more non-priority communication links based on the priority client failing to satisfy one or more performance guarantees on any of the set of multiple communication links.

A non-transitory computer-readable medium storing code for wireless communication is described. The code may include instructions executable by one or more processors to associate a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients and move a non-priority client from a priority communication link to the one or more non-priority communication links based on the priority client failing to satisfy one or more performance guarantees on any of the set of multiple communication links.

Some examples of the method, wireless nodes, and non-transitory computer-readable medium described herein may further include operations, features, means, or instructions for moving the priority client to the priority communication link of the set of multiple communication links based on the priority client failing to satisfy the one or more performance guarantees on any of the set of multiple communication links, where moving the non-priority client may be based on moving the priority client to the priority communication link.

In some examples of the method, wireless nodes, and non-transitory computer-readable medium described herein, movement of the non-priority client may be based on the priority client failing to satisfy one or more performance guarantees on the priority communication link.

In some examples of the method, wireless nodes, and non-transitory computer-readable medium described herein, movement of the non-priority client may be based on the priority client failing to satisfy one or more performance guarantees on the one or more non-priority communication links.

In some examples of the method, wireless nodes, and non-transitory computer-readable medium described herein, movement of the non-priority client includes associating the non-priority client with the one or more non-priority communication links.

Some examples of the method, wireless nodes, and non-transitory computer-readable medium described herein may further include operations, features, means, or instructions for maintaining one or more non-priority clients at the priority communication link based on a traffic load of the priority communication link being less than or equal to a total link capacity of the priority communication link, where movement of the non-priority client may be based on maintaining the one or more non-priority clients at the priority communication link.

Some examples of the method, wireless nodes, and non-transitory computer-readable medium described herein may further include operations, features, means, or instructions for moving the priority client to a multi-link multi-radio mode based on the priority client failing to satisfy the one or more performance guarantees on the priority communication link and the priority communication link failing to may have any non-priority clients capable of being transferred to other communication links.

In some examples of the method, wireless nodes, and non-transitory computer-readable medium described herein, the priority communication link may be selected from the set of multiple communication links based on one or more of a link capacity of the priority communication link relative to link capacities of the set of multiple communication links, a congestion level of the priority communication link relative to congestion levels of the set of multiple communication links, an interference level of the priority communication link relative to interference levels of the set of multiple communication links, and a channel access latency level of the priority communication link relative to channel access latency levels of the set of multiple communication links.

Some examples of the method, wireless nodes, and non-transitory computer-readable medium described herein may further include operations, features, means, or instructions for obtaining one or more stream classification service (SCS) messages to establish a quality of service (QoS) context for a communication flow associated with the priority client, where communicating via the priority communication link may be in accordance with the QoS context.

Some examples of the method, wireless nodes, and non-transitory computer-readable medium described herein may further include operations, features, means, or instructions for establishing a QoS context for a communication flow associated with the priority client in accordance with a classification associated with the communication flow, the classification being in accordance with one or more data packets communicated via the communication flow.

Some examples of the method, wireless nodes, and non-transitory computer-readable medium described herein may further include operations, features, means, or instructions for establishing a QoS context for a communication flow associated with the priority client in accordance with one or more performance guarantees associated with an administration configuration for the set of multiple communication links.

In some examples of the method, wireless nodes, and non-transitory computer-readable medium described herein, one or more antennas may be configured to communicate via the set of multiple communication links, where the wireless nodes may be configured as an AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example physical layer (PHY) protocol data unit (PPDU) usable for communications between a wireless access point (AP) and one or more wireless stations (STAs).

FIG. 3 shows a pictorial diagram of another example wireless communication network.

FIG. 4 shows an example of a process flow that supports link management to improve throughput and operation.

FIG. 5 shows an example of a diagram that supports link management to improve throughput and operation.

FIG. 6 shows an example of a process flow that supports link management to improve throughput and operation.

FIG. 7 shows a block diagram of an example wireless communication device that supports link management to improve throughput and operation.

FIGS. 8 and 9 show flowcharts illustrating example processes performable by or at an AP that supports link management to improve throughput and operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to resource allocation in a wireless network, and more particularly, to balanced admission control of clients to wireless communication links managed by an access point (AP), along with establishment and maintenance of different priority and non-priority wireless links to provide reduced network latency and increased aggregated network throughput. A wireless network may support multi-link operation (MLO) such that a wireless node (e.g., an AP or STA) may communicate over various communication links. In some implementations, an AP may implement a balanced admission control algorithm in order to efficiently distribute clients across links in a way that allows for reduced link crowding, reduced collision relative to random-spraying methods, and relatively even distribution of clients across links in terms of link capacity. The AP may first identify a new client, such as a MLO client or a non-MLO client, that associates with at least one link of the AP. The AP may perform an iterative evaluation of links to determine which link is going to admit the new client. For example, the AP may evaluate whether a quantity of idle clients on the link (such as N_{idle}) is less than a quantity of desired clients on the link (such as N_{desired}), and if the quantity of idle clients is less than the quantity of desired clients on the link, the AP may assign the new client to the link. If the quantity of idle clients is greater than (or equal to) the quantity of desired clients on the link, the AP may evaluate a different link, and may iterate through evaluating each link until the AP determines a link that admits the new client. In some aspects, the AP may perform a calculation in order to determine the quantity of desired idle clients for a link, or otherwise a target quantity of idle clients on the link that allows for efficient resource usage for the link. For example, the AP may determine the desired quantity of idle clients by multiplying a total quantity of idle clients in the network by a ratio of the residual link capacity of the link to a total residual link capacity across all links (such as

$${N}_{d e s i r e d} = {N}_{total} * ( \frac{L {C}_{l i n k}}{L {C}_{t o t a l}} ) ) ,$$

and comparing the result of N_{desired} to the quantity of idle clients on the link in order to determine whether the link may accommodate the new client based on a current utilization of the link capacity.

In some implementations, the AP may support establishment and maintenance of at least one priority link (e.g., “premium” link) along with at least one non-priority links (e.g., “non-premium” links) for association with both service level agreement (SLA) and non-SLA clients (including MLO and non-MLO clients). For example, the priority link may be an example of a link that supports additional available communication resources for use by SLA clients that operate in accordance with an SLA agreement the supports certain target performance metrics. The AP may allocate or reserve at least a portion of the priority link for SLA clients, and while non-SLA clients may gain access to the priority link during times of lower network traffic, the AP may perform link pruning of non-SLA clients to make room for SLA clients on the priority link as network traffic satisfies thresholds.

Particular implementations of the subject matter described in this disclosure can be implemented to realize one or more of the following potential advantages. By performing balanced admission control for new clients, aspects of the subject matter disclosed herein may reduce congestion and collision rate on the communication links while achieving low latency and increased throughput using single assigned communication links. For example, at times that links are near link capacity, balanced admission of clients across links may reduce the likelihood of allocating clients to a link that is beyond capacity, thus reducing the likelihood of collisions on an overly congested link. In addition, the usage of both priority and non-priority links may enable enhanced performance for SLA clients, and increased communications reliability, based on SLA clients having reserved access to the premium link resources (and thus may have less competition for resources from non-SLA clients on the link). Additionally, or alternatively, the assignment of clients to a single link communication link for communicating with the AP may reduce the power consumption of the respective client because the client may no longer need to listen to each of multiple communication links of the AP for indications of queued data.

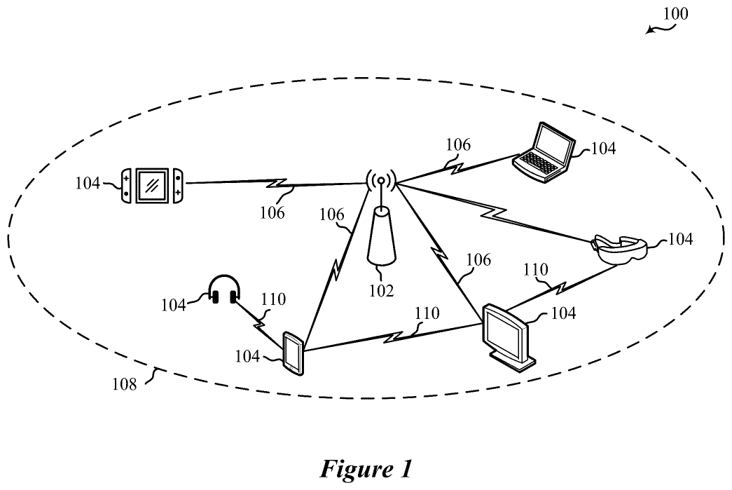

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples. In some implementations, a wireless node may refer to a wireless communication device, such as an AP 102 or a STA 104 that communicates via the wireless communication network 100.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHz), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHZ channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy clients and an O-Primary channel may be specifically used by non-legacy (for example, UHR- or IEEE 802.11bn-compatible) devices for opportunistic access to spectrum that may be otherwise under-utilized.

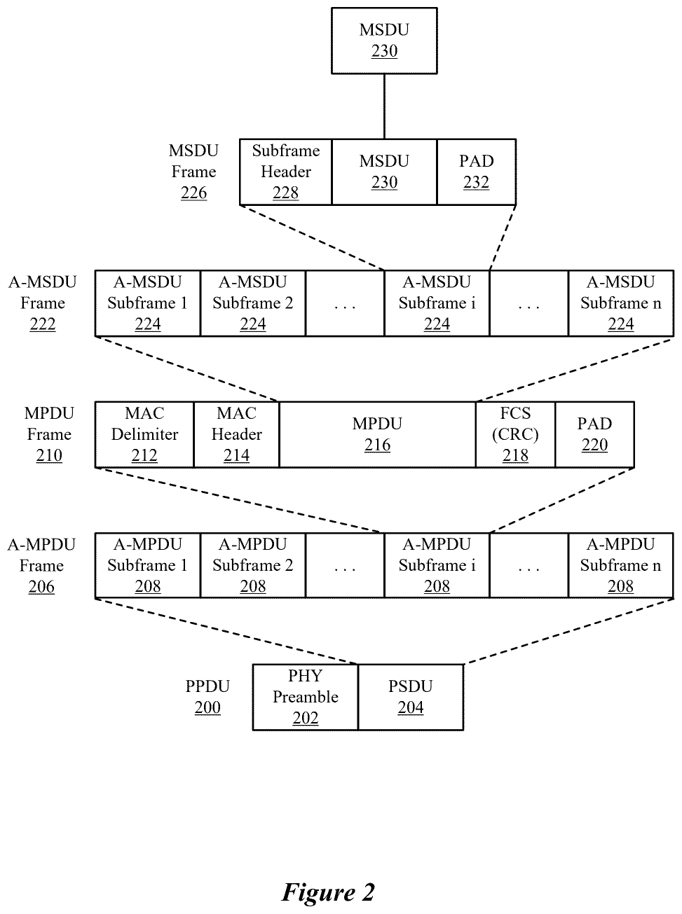

FIG. 2 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (for example, the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some examples, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, cither an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHZ band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHZ, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (cMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (cMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

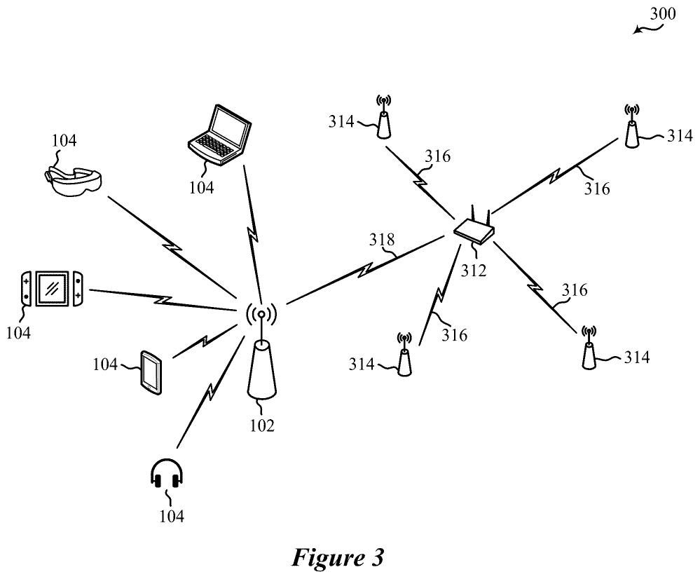

FIG. 3 shows a pictorial diagram of another example wireless communication network 300. According to some aspects, the wireless communication network 300 can be an example of a mesh network, an IoT network, or a sensor network in accordance with one or more of the IEEE 802.11 family of wireless communication protocol standards (including the 802.11ah amendment). The wireless communication network 300 may include multiple wireless communication devices 314, which in some implementations may include APs 102, STAs 104, or both. The wireless communication devices 314 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 314 sense, measure, collect or otherwise obtain and process data and transmit such raw or processed data to an intermediate device 312 for subsequent processing or distribution. Additionally, or alternatively, the intermediate device 312 may transmit control information, digital content (for example, audio or video data), configuration information or other instructions to the wireless communication devices 314. The intermediate device 312 and the wireless communication devices 314 can communicate with one another via wireless communication links 316. In some examples, the wireless communication links 316 include Bluetooth links or other PAN or short-range communication links.

In some examples, the intermediate device 312 also may be configured for wireless communication with other networks such as with a WLAN or a wireless (for example, cellular) wide area network (WWAN), which may, in turn, provide access to external networks including the Internet. For example, the intermediate device 312 may associate and communicate, over a Wi-Fi link 318, with an AP 102 of a wireless communication network 300, which also may serve various STAs 104. In some examples, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some examples, the intermediate device 312 can analyze, preprocess and aggregate data received from the wireless communication devices 314 locally at the edge before transmitting it to other devices or external networks via the Wi-Fi link 318. The intermediate device 312 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

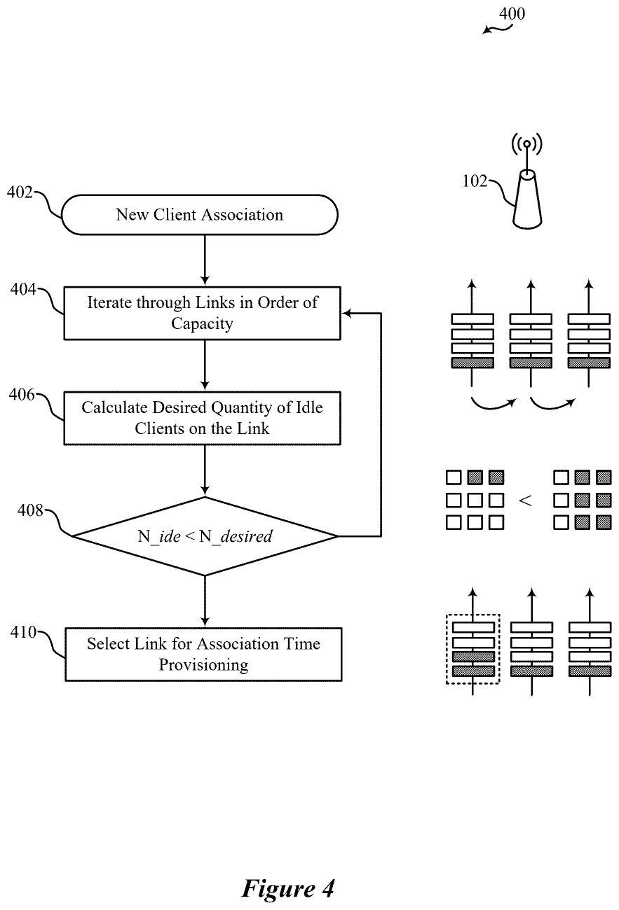

FIG. 4 shows an example of a process flow 400 that supports link management to improve throughput and operation. For example, the process flow 400 may support balanced admission of clients (such as MLO clients or non-MLO clients) to one or more links of an AP 102, which may be an example of an AP 102 described herein. The process flow 400 may be implement an admission control algorithm, or other decision evaluation techniques. Alternative examples of the following may be implemented. Some steps of the process flow 400 may be performed in a different order than described herein or are not performed at all. In some implementations, steps may include additional features not mentioned below, or additional steps may be added. Further, although an AP may perform the operations of the process flow 400, some aspects of some operations also may be performed by one or more other wireless communication devices.

A wireless system may support various resource allocation techniques and communication capabilities, including capabilities of single-link operation (SLO) multi-link operation (MLO), or both. For example, MLO techniques may allow a client (such as an MLO client, an SLA MLO client capable of communicating on one or more links, a multi-link device (e.g., MLD)) to communicate with an AP 102 over up to multiple radios and up to multiple frequency bands at the same time (such as simultaneously). For example, both the AP 102 and the client may transmit and receive data simultaneously over two radios. In some aspects, the two radios may operate in different frequency bands (such as 2.4, 5, or 6 GHz bands, among other possible band) and may select different bands (or a single frequency band) by evaluating which band may provide a highest relative quality of service at the time of the transmission. In some implementations, a client may support different MLO operating modes, including synchronous and asynchronous MLO modes that may be supported based on different capabilities of the client. As used herein, an AP may be configured as an AP MLD or a normal AP.

In some examples, a client may be an MLO client and/or an SLA client, may be an MLO client that is also an SLA client, or may be a non-MLO client that is also a non-SLA client. For example, a client may be an MLO client, and may support communications with the AP 102 using single link and multiple link capabilities (such as the client may associate with a single link or multiple links). In addition, the MLO client may be referred to or categorized as an SLA client. For example, the MLO client may request or require various performance metrics defined by an SLA, such that the MLO client achieves a level of communications quality, network throughput, latency, among other metrics defined or guaranteed by the SLA. In such examples, the client may be referred to as an MLO client, an SLA client, or both, because aspects defining MLO client and SLA client may be associated with the single client. In some aspects, an SLA client may be a client that is provided or guaranteed certain levels of service or service quality. Additionally, or alternatively, an SLA client may be a client that is assigned a priority level (such as from either the AP 102 or from a customer level perspective). In some aspects, an SLA client may be a cost-prioritized client which may define various SLA parameters per-flow of the client. For example, a client may request a certain desired latency for voice data, video data, and other SLA parameters, per flow of the client. Additionally, or alternatively, a user can utilize at least one application programmable interface (API) to select or program different SLA parameters for different clients on different flows, or the selection of different SLA parameters for different clients may be selected and implemented by a classification engine.

In some implementations, the AP 102 may allocate clients to different links based on link metrics including (but not limited to) one or more of channel access latencies, interference levels, traffic loads associated with links, or network congestion associated with the respective communication links, among other metrics. In some implementations of MLO operations, the AP 102 may allocate clients to different communication links using random spraying techniques, which may, in some examples, increase available bandwidth and link capacity for multiple links of the AP 102. In some aspects, however, as the link load approaches a link capacity (such as when client traffic increases and the communication links become saturated with clients), a quantity of collisions between clients may increase due to the random spraying. The challenges associated random spraying of clients onto different links also may reduce the communications performance for SLA clients, with increased collision levels and network congestion reducing the communications quality, which may reduce the likelihood that SLA clients achieve the communications metrics outlined in an SLA.

To achieve higher aggregated throughput and lower aggregated network latency while also decreasing the collision rate of clients allocated to communication links, the AP 102 may support techniques to distribute clients across available links. For example, an AP may implement an admission control mechanism to assign clients to available links in the network, for example, at a time that the clients are establishing a connection with the AP or at times where the client is idle (such as neither transmitting nor receiving data). In some implementations, the admission control mechanism may include an admission control algorithm to distribute clients across the links of the wireless network in a relatively even manner, such that the quantity of clients is relatively evenly distributed across different communication links based on respective link capacities of the communication links.

At 402, a new client may associate on one or more links provided by the AP 102, and the AP 102 may initiate an admission control procedure for the new client, for example an MLO client or a non-MLO client (such as an SLO client). In some examples, if the new client is an MLO client, the new client may associate with a single link of the AP 102, or the client may associate with multiple links of the AP 102. In some other examples, if the new client is an SLO client (or other type of client), the new client may associate with a single link of the AP 102. In some examples, the new client may request association on the one or more links of the AP 102, or the new client may associate with the one or more links of the AP 102 based on an internal call of the AP 102.

At 404, the AP 102 may initiate the admission control algorithm by iterating through each of the one or more links in terms of link capacity to identify a link to admit the new client. For example, the AP 102 may start an iterative evaluation process by first evaluating a link with a highest relative link capacity (such as an initial communication link), then a link with a next highest link capacity, and ending at a link with the lowest relative link capacity (such as a final communication link). In some aspects, the AP 102 may initiate the admission control algorithm after the client has associated with one or more communication links.

To evaluate a link, the AP may, at 406, calculate a “desired” or target quantity of idle clients (such as clients that are neither transmitting nor receiving communications) for the link. The AP may utilize the following Equation 1 to perform the calculation:

$${N}_{d e s i r e d} = {N}_{total} * ( \frac{L {C}_{l i n k}}{L {C}_{total}} ) \qquad ( 1 )$$

In Equation 1, N_{desired} is the desired or target quantity of idle clients on the link (N_{desired} also may be referred to as a threshold quantity of idle clients on the link), Nₜₒₜₐₗ is the total quantity of idle clients in the network, LCₗᵢₙₖ is the residual link capacity of the link, and LCₜₒₜₐₗ is the total residual link capacity of all links associated with the AP 102. At 408, the AP 102 may determine whether N_{idle} is less than N_{desired}, and if N_{idle} is less than N_{desired}, the AP 102 may, select the link to admit the new client (such as if N_{idle}<N_{desired}). If N_{idle} is greater than N_{desired} (such as if N_{idle}>N_{desired}) then the AP 102 may evaluate the next highest capacity link for association with the new client, and may iterate through the links in terms of link capacity to identify a link that may support association with the new client. In some aspects, the admission control algorithm may allow the AP 102 to calculate a target quantity of idle clients for a link, and determine whether addition of the new client would exceed the target quantity of idle clients. Such evaluation may allow the AP 102 to implement balanced admission control for new clients across links, while each link maintains a desired or target quantity of idle clients.

In some aspects, the admission control mechanism may allow for a relatively even distribution of clients across the links based on link capacity. After the AP 102 admits clients to various links, the AP 102 may implement one or more load balancing and link provisioning techniques during ongoing communication in order to maintain a balanced network load across the various links, and to maximize the available airtime for clients. In some aspects, a client such as an MLO client may associate with multiple links of the AP 102, and may be admitted to a single link based on the admission control performed by the AP 102. In some aspects, the AP 102 may receive multiple requests from multiple different clients (or the AP 102 may initiate an admission control procedure to admit the multiple clients, for example, based on an internal call of the AP 102), and may admit each client to respective links based on link capacities of each link, and the iterative evaluation described herein.

For example, at 410, the AP 102 may continuously or periodically monitor the link metrics of the communication links to determine whether lower latencies (e.g., channel access latencies), lower interference levels, or lower traffic loads may be provided by another one or more communication links of the AP 102. For example, if a client is communicating with the AP 102 on first and second communication links, the AP 102 may obtain a first indication that congestion on the first and second communication links is at least equal to the first threshold, and may re-assign the client from the first and second communication links to a single communication link based on the first indication. In some examples, the AP 102 may provision a client operating on a first link to either a second communication link or to multiple communication links based on a congestion level of the first communication link and congestion levels of other links of the other communication links. For example, the AP 102 may provision the client to a different link based on the different link having reduced link congestion relative to the first link. In some other examples, the AP 102 may provision the client to a different link based on a latency requirement of the client communicating over the first communication link or a level of interference experienced by the first communication link. In some examples, the AP may provision the client to a different link based on a collision rate on the first communication link being relatively higher than a collision rate on the different link.

The continuous link management and monitoring may reduce latency and throughput client, and also may reduce interference and traffic load on a per-wireless link basis. In addition, link management techniques may increase or maximize available airtime (such as the percentage of downlink airtime that can be allocated in a link for a new client that is provisioned to the link, assuming the client has fully saturated downlink traffic) for clients allocated to different links, and may support movement between links or link reallocation when one or more breaches occur. For example, a breach may include a per-client SLA breach (such as a failure of an SLA client, which may be an MLO client, to uphold a respective SLA) or a per-link threshold breach (such as exceeding of a traffic load or interference threshold), either or both of which may trigger a network reconfiguration. In some aspects, when the available airtime is near a saturation point at all links of the AP 102, the AP 102 may perform various load balancing techniques to balance or distribute the load across the links.

In some aspects, load balancing techniques may increase (such as maximize) aggregate network throughput and reduce (such as minimize) network latency for a network or AP that serves a relatively large quantity of clients (such as greater than or equal to two clients) by distributing clients across links. For example, if the AP 102 determines that different communications metrics (such as latency, throughput, available airtime) are unbalanced across multiple links (such as the AP determines that one link has significantly better or worse performance than another link) the AP 102 may dynamically re-assign one or more clients between communication links to achieve similar link metrics for each of the communication links. Such load balancing and provisioned mode operation also may reduce the collision probability of clients in the network, which increases the throughput and reduces communications latency for clients.

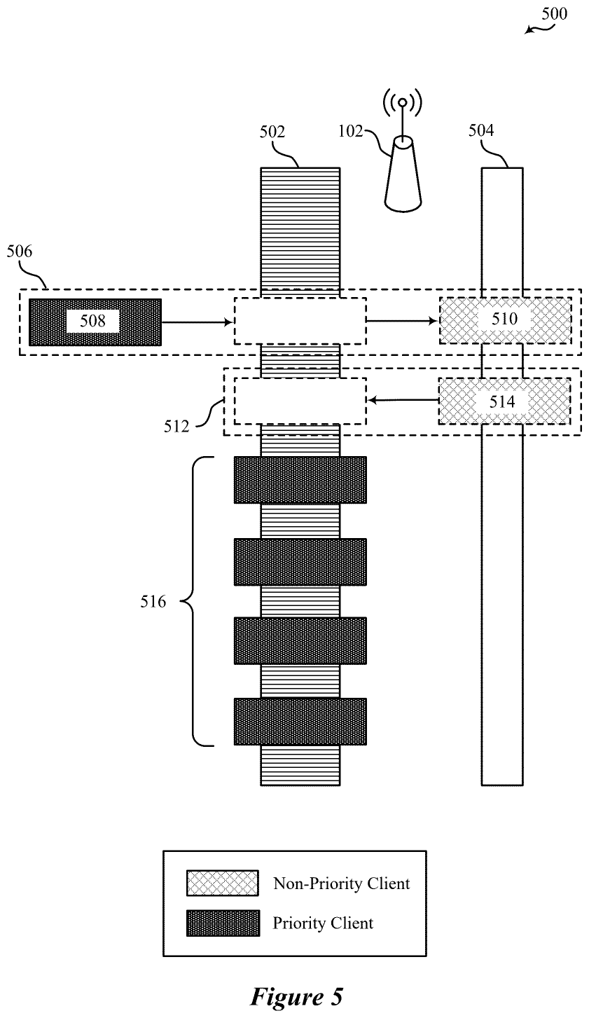

FIG. 5 shows an example of a diagram 500 that supports link management to improve throughput and operation. For example, the diagram 500 may support admission, allocation, and distribution of clients (such as MLO clients or non-MLO clients) to one or more links of an AP 102, which may be an example of an AP 102 described herein.

In some wireless systems, a network device such as an AP 102 may provide access to a set of communication links that different clients may access. In some aspects, the AP 102 may allocate a separate communications link (such as a priority or “premium” communications link) to a certain type of client, such as a priority client or an SLA client. Additionally, or alternatively, the AP 102 may allocate a portion of a priority communication link for access by priority clients, with a remaining portion of the priority communication link being available for either priority clients or non-priority clients. In some aspects, a priority communication link may provide communications metrics or services that satisfy an SLA for the priority clients, for example, the AP 102 may provide a certain quality of communication that satisfy various expected performance guarantees. For example, the performance guarantees may be an example of SLA requirements and may include latency targets, throughput targets, bandwidth and packet loss expectations, among other agreed targets. In some aspects, an SLA client (or the performance guarantees more generally) may be configured by the AP 102, or may be required from a client such as a stream classification service (SCS). For example, the AP 102 may communicate (e.g., obtain or receive) one or more SCS messages to establish a quality of service (QoS) context for a communication flow associated with the priority client, so that communications between the AP and the client occur in accordance with the QoS context (which may be established in accordance with at least one performance guarantee). In some cases, the AP 102 may establish a QoS context for a communication flow associated with the priority client in accordance with a classification associated with the communication flow. The classification may be in accordance with one or more data packets communicated via the communication flow (e.g., over the plurality of communication links).

In some implementations, the AP 102 may increase throughput and reduce latency for clients by performing link provisioning, among other techniques. If the SLA client is operating in a multi-link multi-radio (MLMR) mode, however, the SLA client may compete with other clients including both non-priority clients (such as non-SLA clients) and priority clients (such as SLA clients) to gain or maintain access on a link, which may, depending on various factors such as network saturation, not satisfy the performance targets of the performance guarantees (e.g., the SLA requirements).

To increase the communications quality and reliability of link allocation for different clients, the AP 102 may support different link classifications. For example, the AP 102 may establish a “premium” link or priority link 502, along with one or more non-priority links 504. In some examples, the priority link 502 may have additional available airtime reserved for SLA clients (relative to the available airtime on the one or more non-priority links), or may be configured to support one or more performance guarantees for an SLA client. For example, a portion of the priority link 502 may be reserved for use by SLA clients, or the entire priority link 502 may be reserved for use by SLA clients, or may be capable of being reserved at least partially for use by SLA clients. In some examples, the priority link 502 may be associated with a highest bandwidth, a highest channel capacity, or have a highest communications quality out of each of the links associated with the AP 102, or the priority link 502 may be configured or managed by the client to support different communication metrics. In some examples, the priority link 502 may be a communication link that has a highest relative link capacity of all links associated with the AP 102, or may be selected based on a congestion level of the link relative to other links, an interference level of the link relative to other links, a channel access latency level of the link relative to other links, among other possible link metrics. In addition, the priority link 502 may support non-SLA client usage. For example, at times that SLA clients are meeting their performance guarantees and thus do not require the medium time occupied by non-SLA clients on the priority link 502. In some examples, the priority link may be at least partially reserved for SLA clients 516 (such as a certain percentage or fraction of the available bandwidth of the priority link 502 may be reserved for SLA client use), but at least some portion of the priority link 502 may accommodate non-SLA clients, for example, when a quantity of SLA clients utilizing the priority link 502 is lower than a threshold.

In some implementations, the AP 102 may perform link pruning procedures to support SLA client access to the priority link 502. For example, during procedure 506 the AP 102 may make room for an SLA client 508 on the priority link 502 by moving a non-SLA client 510 from the priority link 502 to the non-priority link 504 (included in a set of non-priority links). Additionally, or alternatively, during procedure 512, the AP 102 may move (such as by provisioning) a non-SLA client 514 from the non-priority link 504 to the priority link 502 (based on sufficient link capacity of the priority link 502). In some examples, the AP 102 may perform inter-link BSS transition in order to move a non-SLA client between links. In some other examples, if the link capacity is met or exceeded with all SLA clients for the priority link, the AP 102 may choose whether to admit a new SLA client to the priority link based on a comparison of priorities between SLA clients (such as based on SLA parameters such as target latency and throughput values of different SLA clients). In some examples, the AP 102 may admit clients to various links based on one or more criteria such as link capacity, packet error rate for the links, or both. For example, the AP 102 may first admit clients to a link having a highest link capacity, or a lowest packet error rate, or both.

In some implementations, the AP 102 may perform link management based on identification of an SLA breach. For example, an SLA breach may involve a failure of communications with an SLA client to meet the terms and conditions outlined in a performance guarantee associated with the client (e.g., an SLA requirement associated with the SLA client), including, for example, a level of service expected including performance metrics, latency, throughput, available bandwidth, and other aspects. In examples that an SLA breach occurs (such as in a non-priority link), the AP 102 may move a client to the priority link considering the estimated resultant available airtime in the priority link satisfies a predetermined threshold. In some other examples that the SLA breach occurs (such as a communication flow associated with a client violates its performance guarantees) the AP 102 may prune the priority link to remove non-SLA clients from the priority link in order to make room for an SLA client. In some examples where there is no non-SLA candidates left to prune on the priority link, the AP 102 may move one or more SLA clients to an MLMR mode with static link assignment. In some aspects, the AP 102 may initiate an admission control procedure to admit a first priority client to the priority link, and may move a second priority client to MLMR mode based on the second priority client failing to satisfy one or more SLA requirements on the priority link, and based on there being no non-SLA clients left to prune from the priority link.

In some aspects, the AP 102 may obtain one or more SCS messages to establish a QoS context for a communication flow associated with a priority client, such that communicating via the priority link is in accordance with the QoS context. In some aspects, the QoS may be associated with a communication flow associated with the priority client and in accordance with a classification associated with the communication flow, such as for one or more data packets communicated over the communication flow. In some aspects, the QoS context may be established based on one or more SLA configurations (e.g., performance guarantees) for a client.

In some aspects, the utilization of the priority and non-priority links in a wireless network may support reliable performance and efficient utilization of network resources for SLA clients and non-SLA clients, while supporting dynamic management of different network links.

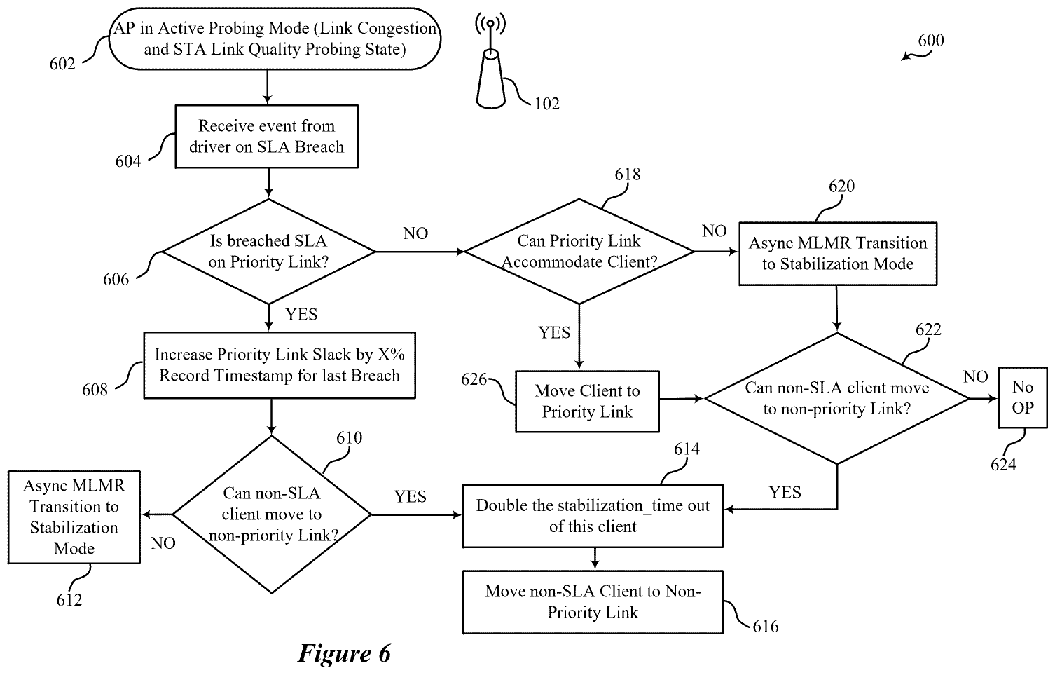

FIG. 6 shows an example of a process flow 600 that supports link management to improve throughput and operation. For example, process flow 600 may illustrate a link pruning procedure (such as a link pruning algorithm) that supports maintenance of one or more links at a wireless device such as an AP 102 described herein, including at least one priority link and at least one non-priority link. Alternative examples of the following may be implemented. Some steps are performed in a different order than described herein or are not performed at all. In some implementations, steps may include additional features not mentioned below, or additional steps may be added. Further, although an AP may perform the operations of the process flow 600, some aspects of some operations also may be performed by one or more other wireless communication devices.

At 602, the AP 102 may support or otherwise operate in an active probing mode, for example, a link congestion and STA link quality probing state where the AP 102 may monitor one or more communication links and one or more STAs (such as clients such as SLA clients) accessing the one or more communication links. While operating in the active probing mode, the AP 102 may perform periodic monitoring of a link congestion level for a priority link to determine whether to initiate link pruning of the priority link. At 604, the AP 102 may receive an indication of an event from a driver, which indicates an SLA breach on one or more of the communication links. If at 606 the AP 102 determines that the SLA breach occurs on the priority link, the AP 102 may increase a slack of the priority link by a threshold percentage (such as X % increase), and may record a timestamp Tbreach that is indicative of the time of occurrence for the breach at 608. At 610, the AP 102 may determine whether any non-SLA client may be moved to a non-premium link (such as from the premium link to a non-premium link) based on available airtime and client consumption. If the AP 102 determines that one or more non-SLA clients may not be moved to a non-premium link, the AP 102 may perform an asynchronous MLMR transition to a stabilization mode at 612. If the AP 102 determines that one or more non-SLA clients may be moved to a non-premium link, the AP 102 may increase (such as double) the stabilization time out for the client at 614, and may move the non-SLA client to the non-priority link at 616.

In some other aspects, at 606, the AP 102 may determine that the SLA breach occurs on one or more non-priority links. The AP 102 may then at 618 determine whether the priority link may accommodate the client based on available airtime and client consumption on the priority link. If the AP 102 determines that the priority link may accommodate the client, the AP 102 may move the client to the priority link at 626. If the AP 102 determines that the priority link may not accommodate the client, the AP 102 may perform an asynchronous MLMR transition to stabilization mode at 620. The AP 102 may then determine at 622 whether the non-SLA client may move to the non-priority link. If the non-SLA client cannot move to the non-priority link, then the AP 102 may not move the non-SLA client to the non-priority link at 624. If the AP 102 determines that the non-SLA client may be moved to the non-priority link, the AP 102 may increase (such as double) the stabilization time out for the client at 614, and may move the non-SLA client to the non-priority link at 616.

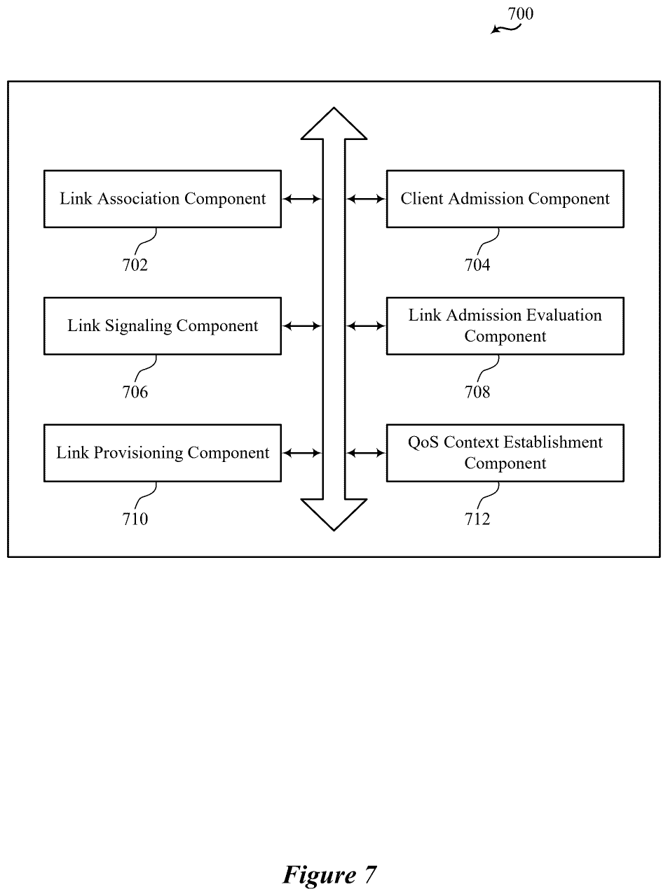

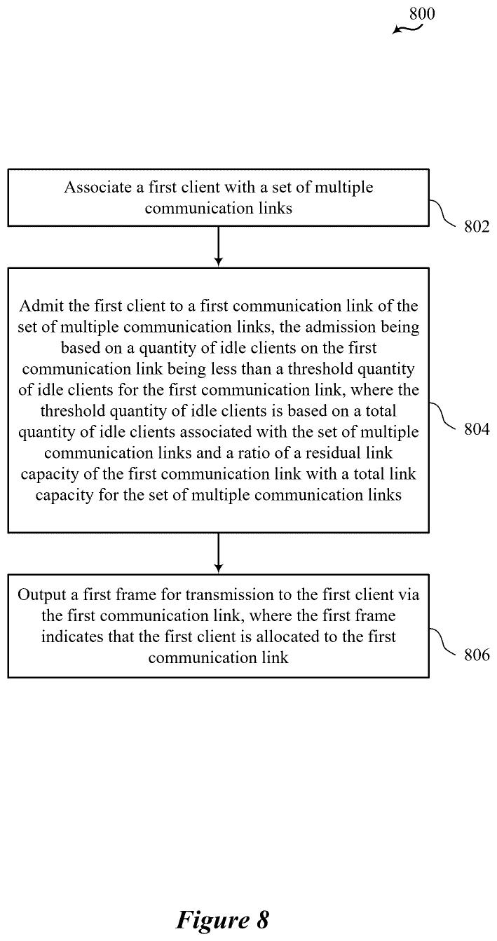

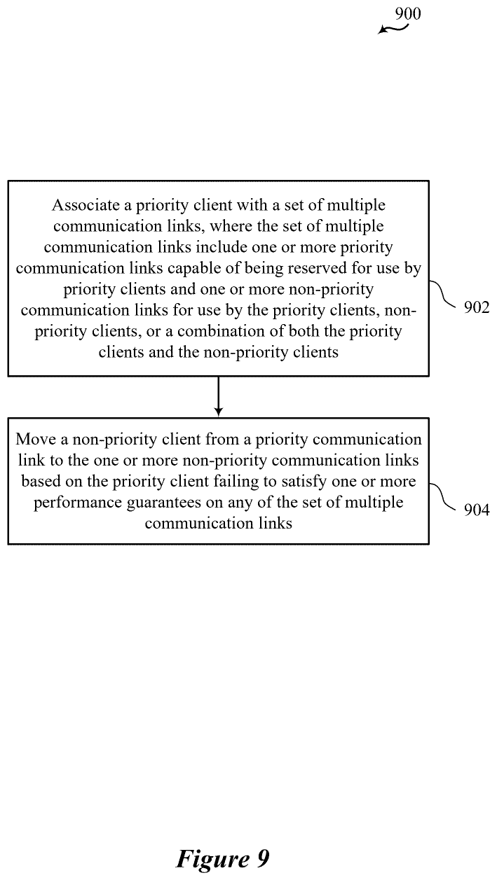

FIG. 7 shows a block diagram of an example wireless communication device 700 that supports link management to improve throughput and operation. In some examples, the wireless communication device 700 is configured to perform the processes 800 and 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

Further, various components of the wireless communication device 700 may provide means for performing the methods described herein. In some examples, means for transmitting and/or receiving may include the transceivers and/or antenna(s) of the wireless communication device 700. In some examples, means for outputting or sending (such as means for outputting for transmission) and means for obtaining (such as means for obtaining after information is received from a different device) may include one or more interfaces of the wireless communication device 700 to output signals to other components or obtain signals from other components of the wireless communication device 700. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for obtaining, means for associating, means for initiating, means for admitting, means for outputting, means for evaluating, means for selecting, means for provisioning, means for generating, means for communicating, means for establishing, means for performing, means for maintaining, and/or means for moving, include a processing system, processor circuitry (including one or more processors), memory circuitry, and/or computer-readable media of the wireless communication device 700.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a link association component 702, a client admission component 704, a link signaling component 706, a link admission evaluation component 708, a link provisioning component 710, and a QoS context establishment component 712. Portions of one or more of the link association component 702, the client admission component 704, the link signaling component 706, the link admission evaluation component 708, the link provisioning component 710, and the QoS context establishment component 712 may be implemented at least in part in hardware or firmware. For example, one or more of the link association component 702, the client admission component 704, the link signaling component 706, the link admission evaluation component 708, the link provisioning component 710, and the QoS context establishment component 712 may be implemented at least in part by at least a processor or a modem. In some examples, portions of one or more of the link association component 702, the client admission component 704, the link signaling component 706, the link admission evaluation component 708, the link provisioning component 710, and the QoS context establishment component 712 may be implemented at least in part by a processor and software in the form of processor-executable code stored in memory.

The wireless communication device 700 may support wireless communication in accordance with examples as disclosed herein. The link association component 702 is configurable or configured to associate a first client with a set of multiple communication links. The client admission component 704 is configurable or configured to admit the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total residual link capacity for the set of multiple communication links. The link signaling component 706 is configurable or configured to output a first frame for transmission to the first client via the first communication link, where the first frame indicates that the first client is allocated to the first communication link. In some examples, the threshold quantity of idle clients is equal to the total quantity of idle clients multiplied by the ratio of the residual link capacity of the first communication link to the total residual link capacity for the set of multiple communication links.

In some examples, the link admission evaluation component 708 is configurable or configured to evaluate each communication link of the set of multiple communication links that includes that first communication link to admit the first client in an order, the order being based on a capacity of each communication link relative to capacities of other communication links of the set of multiple communication links, where the admission is based on the evaluation. In some examples, the order of evaluating the set of multiple communication links begins with an initial communication link with a highest relative link capacity and ends with a final communication link with a lowest relative link capacity. In some examples, the quantity of idle clients on the first communication link includes the quantity of idle clients on the first communication link at a time of the evaluation of the first communication link.

In some examples, the link association component 702 is configurable or configured to associate a second client with the set of multiple communication links. In some examples, the client admission component 704 is configurable or configured to admit the second client to a second communication link of the set of multiple communication links based on the quantity of idle clients on the first communication link being greater than or equal to a threshold quantity of idle clients for the first communication link, and the quantity of idle clients on the second communication link being less than the threshold quantity of idle clients for the second communication link.

In some examples, to support admitting the second client to the second communication link, the link admission evaluation component 708 is configurable or configured to evaluate whether to admit the first client to the first communication link if the quantity of idle clients on the first communication link is less than the threshold quantity of idle clients for the first communication link. In some examples, to support admitting the second client to the second communication link, the link admission evaluation component 708 is configurable or configured to select the second communication link based on a failure to admit the second client on the first communication link, where the second communication link having a next highest link capacity relative to the first communication link. In some examples, to support admitting the second client to the second communication link, the client admission component 704 is configurable or configured to admit the second client to the second communication link based on the quantity of idle clients on the second communication link being less than a threshold quantity of idle clients for the second communication link.

In some examples, the link association component 702 is configurable or configured to associate each of a set of multiple clients to one of the set of multiple communication links, where the set of multiple clients include the first client. In some examples, the client admission component 704 is configurable or configured to admit the set of multiple clients to respective communication links in accordance with respective link capacities of the respective communication links. In some examples, to support admitting the set of multiple clients to the respective communication links, the client admission component 704 is configurable or configured to admit the set of multiple clients to the respective communication links based on the quantity of idle clients on a respective communication link being equal to the threshold quantity of idle clients for the respective communication link. In some examples, the admission of the set of multiple clients to the respective communication links begins with admission of the first client to the first communication link, the first communication link having a higher link capacity relative to other communication links of the set of multiple communication links.

In some examples, the link provisioning component 710 is configurable or configured to provision the first client to either a second communication link or multiple communication links based on at least one of a congestion level of the first communication link and congestion levels of other links of the set of multiple communication links, a latency requirement of the first client communicating over the first communication link, or a level of interference experienced by the first communication link, or a collision rate on the first communication link. In some examples, the link signaling component 706 is configurable or configured to generate the first frame indicating the first client is allocated to the first communication link. In some examples, one or more transceivers may be configured to transmit the first frame, where the apparatus transmitting the first frame is configured as an AP.

Additionally, or alternatively, the wireless communication device 700 may support wireless communication in accordance with examples as disclosed herein. In some examples, the link association component 702 is configurable or configured to associate a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients. In some examples, the client admission component 704 is configurable or configured to move a non-priority client from a priority communication link to the one or more non-priority communication links based on the priority client failing to satisfy one or more performance guarantees on any of the set of multiple communication links.

In some examples, the client admission component 704 is configurable or configured to move the priority client to the priority communication link of the set of multiple communication links based on the priority client failing to satisfy the one or more performance guarantees on any of the set of multiple communication links, where moving the non-priority client is based on moving the priority client to the priority communication link. In some examples, movement of the non-priority client is based on the priority client failing to satisfy one or more performance guarantees on the priority communication link. In some examples, movement of the non-priority client is based on the priority client failing to satisfy one or more performance guarantees on the one or more non-priority communication links. In some examples, movement of the non-priority client includes associating the non-priority client with the one or more non-priority communication links.

In some examples, the link admission evaluation component 708 is configurable or configured to maintain one or more non-priority clients at the priority communication link based on a traffic load of the priority communication link being less than or equal to a total residual link capacity of the priority communication link, where movement of the non-priority client is based on maintaining the one or more non-priority clients at the priority communication link.

In some examples, the link admission evaluation component 708 is configurable or configured to move the priority client to a multi-link multi-radio mode based on the priority client failing to satisfy the one or more performance guarantees on the priority communication link and the priority communication link failing to have any non-priority clients capable of being transferred to other communication links.

In some examples, the priority communication link is selected from the set of multiple communication links based on one or more of a link capacity of the priority communication link relative to link capacities of the set of multiple communication links, a congestion level of the priority communication link relative to congestion levels of the set of multiple communication links, an interference level of the priority communication link relative to interference levels of the set of multiple communication links, and a channel access latency level of the priority communication link relative to channel access latency levels of the set of multiple communication links.

In some examples, the QoS context establishment component 712 is configurable or configured to obtain one or more SCS messages to establish a QoS context for a communication flow associated with the priority client, where communicating via the priority communication link is in accordance with the Qos context. In some examples, the QoS context establishment component 712 is configurable or configured to establish a QoS context for a communication flow associated with the priority client in accordance with a classification associated with the communication flow, the classification being in accordance with one or more data packets communicated via the communication flow. In some examples, the QoS context establishment component 712 is configurable or configured to establish a QoS context for a communication flow associated with the priority client in accordance with one or more performance guarantees associated with an administration configuration for the plurality of communication links. In some examples, one or more antennas may be configured to communicate via the set of multiple communication links, where the apparatus comprising the one or more antennas is configured as an AP.

FIG. 8 shows a flowchart illustrating an example process 800 performable by or at an apparatus that supports link management to improve throughput and operation. The operations of the process 800 may be implemented by an apparatus or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 802, the apparatus may associate a first client with a set of multiple communication links. The operations of 802 may be performed in accordance with examples as disclosed herein. In some implementations, aspects of the operations of 802 may be performed by a link association component 702 as described with reference to FIG. 7.

In some examples, in 804, the apparatus may admit the first client to a first communication link of the set of multiple communication links, the admission being based on a quantity of idle clients on the first communication link being less than a threshold quantity of idle clients for the first communication link, where the threshold quantity of idle clients is based on a total quantity of idle clients associated with the set of multiple communication links and a ratio of a residual link capacity of the first communication link with a total residual link capacity for the set of multiple communication links. The operations of 804 may be performed in accordance with examples as disclosed herein. In some implementations, aspects of the operations of 804 may be performed by a client admission component 704 as described with reference to FIG. 7.

In some examples, in 806, the apparatus may output a first frame for transmission to the first client via the first communication link, where the first frame indicates that the first client is allocated to the first communication link. The operations of 806 may be performed in accordance with examples as disclosed herein. In some implementations, aspects of the operations of 806 may be performed by a link signaling component 706 as described with reference to FIG. 7.

FIG. 9 shows a flowchart illustrating an example process 900 performable by or at an apparatus that supports link management to improve throughput and operation. The operations of the process 900 may be implemented by an apparatus or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 902, the apparatus may associate a priority client with a set of multiple communication links, where the set of multiple communication links include one or more priority communication links capable of being reserved for use by priority clients and one or more non-priority communication links for use by the priority clients, non-priority clients, or a combination of both the priority clients and the non-priority clients. The operations of 902 may be performed in accordance with examples as disclosed herein. In some implementations, aspects of the operations of 902 may be performed by a link association component 702 as described with reference to FIG. 7.

In some examples, in 904, the apparatus may move a non-priority client from a priority communication link to the one or more non-priority communication links based on the priority client failing to satisfy one or more performance guarantees on any of the set of multiple communication links. The operations of 904 may be performed in accordance with examples as disclosed herein. In some implementations, aspects of the operations of 904 may be performed by a client admission component 704 as described with reference to FIG. 7.

Implementation examples are described in the following numbered clauses:

Aspect 1: A method for wireless communication at a wireless node, comprising: associating a first client with a plurality of communication links; admitting the first client to a first communication link of the plurality of communication links, the admission being based at least in part on a quantity of idle clients on the first communication link being less than a threshold quantity of idle clients for the first communication link, wherein the threshold quantity of idle clients is based at least in part on a total quantity of idle clients associated with the plurality of communication links and a ratio of a residual link capacity of the first communication link with a total link capacity for the plurality of communication links; and outputting a first frame for transmission to the first client via the first communication link, wherein the first frame indicates that the first client is allocated to the first communication link.

Aspect 2: The method of aspect 1, wherein the threshold quantity of idle clients is equal to the total quantity of idle clients multiplied by the ratio of the residual link capacity of the first communication link to the total link capacity for the plurality of communication links.

Aspect 3: The method of any of aspects 1 through 2, further comprising: evaluating each communication link of the plurality of communication links that includes that first communication link to admit the first client in an order, the order being based on a capacity of each communication link relative to capacities of other communication links of the plurality of communication links, wherein the admission is based on the evaluation.

Aspect 4: The method of aspect 3, wherein the order of evaluating the plurality of communication links begins with an initial communication link with a highest relative link capacity and ends with a final communication link with a lowest relative link capacity.

Aspect 5: The method of any of aspects 3 through 4, wherein the quantity of idle clients on the first communication link comprises the quantity of idle clients on the first communication link at a time of the evaluation of the first communication link.

Aspect 6: The method of any of aspects 1 through 5, further comprising: associating a second client with the plurality of communication links; and admitting the second client to a second communication link of the plurality of communication links based at least in part on the quantity of idle clients on the first communication link being greater than or equal to a threshold quantity of idle clients for the first communication link, and the quantity of idle clients on the second communication link being less than the threshold quantity of idle clients for the second communication link.

Aspect 7: The method of aspect 6, wherein admitting the second client to the second communication link comprises: evaluating whether to admit the first client to the first communication link if the quantity of idle clients on the first communication link is less than the threshold quantity of idle clients for the first communication link; selecting the second communication link based at least in part on a failure to admit the second client on the first communication link, wherein the second communication link having a next highest link capacity relative to the first communication link; and admitting the second client to the second communication link based at least in part on the quantity of idle clients on the second communication link being less than a threshold quantity of idle clients for the second communication link.

Aspect 8: The method of any of aspects 1 through 7, further comprising: associating each of a plurality of clients to one of the plurality of communication links, wherein the plurality of clients include the first client; and admitting the plurality of clients to respective communication links in accordance with respective link capacities of the respective communication links.

Aspect 9: The method of aspect 8, wherein admitting the plurality of clients to the respective communication links comprises: admitting the plurality of clients to the respective communication links based at least in part on the quantity of idle clients on a respective communication link being equal to the threshold quantity of idle clients for the respective communication link.

Aspect 10: The method of any of aspects 8 through 9, wherein the admission of the plurality of clients to the respective communication links begins with admission of the first client to the first communication link, the first communication link having a higher link capacity relative to other communication links of the plurality of communication links.

Aspect 11: The method of any of aspects 1 through 10, further comprising: provisioning the first client to either a second communication link or multiple communication links based on at least one of a congestion level of the first communication link and congestion levels of other links of the plurality of communication links, a latency requirement of the first client communicating over the first communication link, or a level of interference experienced by the first communication link, or a collision rate on the first communication link.

Aspect 12: The method of any of aspects 1 through 11, further comprising: generating the first frame indicating the first client is allocated to the first communication link.

Aspect 13: A method for wireless communication at a wireless node, comprising: associating a priority client with a plurality of communication links, wherein the plurality of communication links comprise one or more priority communication links capable of being reserved for use by priority clients and one or more non-priority communication links for use by the priority clients, non-priority clients, or a combination of both the priority clients and the non-priority clients; and moving a non-priority client from a priority communication link to the one or more non-priority communication links based at least in part on the priority client failing to satisfy one or more performance guarantees on any of the plurality of communication links.

Aspect 14: The method of aspect 13, further comprising: moving the priority client to the priority communication link of the plurality of communication links based on the priority client failing to satisfy the one or more performance guarantees on any of the plurality of communication links, wherein moving the non-priority client is based at least in part on moving the priority client to the priority communication link.

Aspect 15: The method of any of aspects 13 through 14, wherein movement of the non-priority client is based at least in part on the priority client failing to satisfy one or more performance guarantees on the priority communication link.

Aspect 16: The method of any of aspects 13 through 15, wherein movement of the non-priority client is based at least in part on the priority client failing to satisfy one or more performance guarantees on the one or more non-priority communication links.

Aspect 17: The method of any of aspects 13 through 16, wherein movement of the non-priority client comprises associating the non-priority client with the one or more non-priority communication links.

Aspect 18: The method of any of aspects 13 through 17, further comprising: maintaining one or more non-priority clients at the priority communication link based at least in part on a traffic load of the priority communication link being less than or equal to a total link capacity of the priority communication link, wherein movement of the non-priority client is based on maintaining the one or more non-priority clients at the priority communication link.

Aspect 19: The method of any of aspects 13 through 18, further comprising: moving the priority client to a multi-link multi-radio mode based at least in part on the priority client failing to satisfy the one or more performance guarantees on the priority communication link and the priority communication link failing to have any non-priority clients capable of being transferred to other communication links.

Aspect 20: The method of any of aspects 13 through 19, wherein the priority communication link is selected from the plurality of communication links based on one or more of a link capacity of the priority communication link relative to link capacities of the plurality of communication links, a congestion level of the priority communication link relative to congestion levels of the plurality of communication links, an interference level of the priority communication link relative to interference levels of the plurality of communication links, and a channel access latency level of the priority communication link relative to channel access latency levels of the plurality of communication links.

Aspect 21: The method of any of aspects 13 through 20, further comprising: obtaining one or more SCS messages to establish a QoS context for a communication flow associated with the priority client, wherein communicating via the priority communication link is in accordance with the QoS context.

Aspect 22: The method of any of aspects 13 through 21, further comprising: establishing a QoS context for a communication flow associated with the priority client in accordance with a classification associated with the communication flow, the classification being in accordance with one or more data packets communicated via the communication flow.

Aspect 23: The method of any of aspects 13 through 22, further comprising: establishing a QoS context for a communication flow associated with the priority client in accordance with one or more performance guarantees associated with an administration configuration for the plurality of communication links.

Aspect 24: A wireless node for wireless communication, including at least one transceiver, and a processing system that includes processor circuitry and memory circuitry that stores code, the processing system configured to cause the wireless node to perform the method of any of aspects 1 through 12, wherein the processing system is configured to associate a first client with a plurality of communication links and admit the first client to a first communication link of the plurality of communication links, and wherein the at least one transceiver is configured to output a first frame for transmission to the first client via the first communication link.

Aspect 25: An apparatus for wireless communication, including a processing system that includes processor circuitry and memory circuitry that stores code, the processing system configured to cause the apparatus to perform the method of any of aspects 1 through 12.

Aspect 26: An apparatus for wireless communication, comprising at least one means for performing the method of any of aspects 1 through 12.

Aspect 27: A non-transitory computer-readable medium storing code for wireless communication, the code comprising instructions executable by one or more processors to perform a method of any of aspects 1 through 12.

Aspect 28: A wireless node for wireless communication, including at least one transceiver, and a processing system that includes processor circuitry and memory circuitry that stores code, the processing system configured to cause the wireless node to perform the method of any of aspects 13 through 23, wherein the processing system or the at least one transceiver is configured to associate a priority client with a plurality of communication links and move a non-priority client from a priority communication link to the one or more non-priority communication links.

Aspect 29: An apparatus for wireless communication, including a processing system that includes processor circuitry and memory circuitry that stores code, the processing system configured to cause the apparatus to perform the method of any of aspects 13 through 23.

Aspect 30: An apparatus for wireless communication, comprising at least one means for performing the method of any of aspects 13 through 23.

Aspect 31: A non-transitory computer-readable medium storing code for wireless communication, the code comprising instructions executable by one or more processors to perform a method of any of aspects 13 through 23.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of”′ a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
associate a first client with a plurality of communication links;
admit the first client to a first communication link of the plurality of communication links, the admission being based at least in part on a quantity of idle clients on the first communication link being less than a threshold quantity of idle clients for the first communication link, wherein the threshold quantity of idle clients is based at least in part on a total quantity of idle clients associated with the plurality of communication links and a ratio of a residual link capacity of the first communication link with a total residual link capacity for the plurality of communication links; and
output a first frame for transmission to the first client via the first communication link, wherein the first frame indicates that the first client is allocated to the first communication link.

2. The apparatus of claim 1, wherein the threshold quantity of idle clients is equal to the total quantity of idle clients multiplied by the ratio of the residual link capacity of the first communication link to the total residual link capacity for the plurality of communication links.

3. The apparatus of claim 1, wherein the processing system is further configured to cause the apparatus to:
evaluate each communication link of the plurality of communication links that includes that first communication link to admit the first client in an order, the order being based on a capacity of each communication link relative to capacities of other communication links of the plurality of communication links, wherein the admission is based on the evaluation.

4. The apparatus of claim 3, wherein the order of evaluating the plurality of communication links begins with an initial communication link with a highest relative link capacity and ends with a final communication link with a lowest relative link capacity.

5. The apparatus of claim 1, wherein the processing system is further configured to cause the apparatus to:
associate a second client with the plurality of communication links; and
admit the second client to a second communication link of the plurality of communication links based at least in part on the quantity of idle clients on the first communication link being greater than or equal to a threshold quantity of idle clients for the first communication link, and the quantity of idle clients on the second communication link being less than the threshold quantity of idle clients for the second communication link.

6. The apparatus of claim 5, wherein, to admit the second client to the second communication link, the processing system is configured to cause the apparatus to:
evaluate whether to admit the first client to the first communication link if the quantity of idle clients on the first communication link is less than the threshold quantity of idle clients for the first communication link;
select the second communication link based at least in part on a failure to admit the second client on the first communication link, wherein the second communication link having a next highest link capacity relative to the first communication link; and
admit the second client to the second communication link based at least in part on the quantity of idle clients on the second communication link being less than a threshold quantity of idle clients for the second communication link.

7. The apparatus of claim 1, wherein the processing system is further configured to cause the apparatus to:
associate each of a plurality of clients to one of the plurality of communication links, wherein the plurality of clients include the first client; and
admit the plurality of clients to respective communication links in accordance with respective link capacities of the respective communication links.

8. The apparatus of claim 7, wherein, to admit the plurality of clients to the respective communication links, the processing system is configured to cause the apparatus to:
admit the plurality of clients to the respective communication links based at least in part on the quantity of idle clients on a respective communication link being equal to the threshold quantity of idle clients for the respective communication link.

9. The apparatus of claim 1, further comprises:
one or more transceivers configure to transmit the first frame, wherein the apparatus is configured as an access point (AP).

10. An apparatus for wireless communication, comprising:
a processing system that includes processor circuitry and memory circuitry that stores code, the processing system configured to cause the apparatus to:
associate a priority client with a plurality of communication links, wherein the plurality of communication links comprise one or more priority communication links capable of being reserved for use by priority clients and one or more non-priority communication links for use by the priority clients, non-priority clients, or a combination of both the priority clients and the non-priority clients; and
move a non-priority client from a priority communication link to the one or more non-priority communication links based at least in part on the priority client failing to satisfy one or more performance guarantees on any of the plurality of communication links.

11. The apparatus of claim 10, wherein the processing system is further configured to cause the apparatus to:
move the priority client to the priority communication link of the plurality of communication links based at least in part on the priority client failing to satisfy the one or more performance guarantees on any of the plurality of communication links, wherein moving the non-priority client is based on moving the priority client to the priority communication link.

12. The apparatus of claim 10, wherein movement of the non-priority client is based at least in part on the priority client failing to satisfy one or more performance guarantees on the priority communication link or the one or more non-priority communication links.

13. The apparatus of claim 10, wherein the processing system is further configured to cause the apparatus to:
maintain one or more non-priority clients at the priority communication link based at least in part on a traffic load of the priority communication link being less than or equal to a total residual link capacity of the priority communication link, wherein movement of the non-priority client is based on maintaining the one or more non-priority clients at the priority communication link.

14. The apparatus of claim 10, wherein the processing system is further configured to cause the apparatus to:
move the priority client to a multi-link multi-radio mode based at least in part on the priority client failing to satisfy the one or more performance guarantees on the priority communication link and the priority communication link failing to have any non-priority clients capable of being transferred to other communication links.

15. The apparatus of claim 10, wherein the priority communication link is selected from the plurality of communication links based on one or more of:
a link capacity of the priority communication link relative to link capacities of the plurality of communication links;
a congestion level of the priority communication link relative to congestion levels of the plurality of communication links;
an interference level of the priority communication link relative to interference levels of the plurality of communication links; and
a channel access latency level of the priority communication link relative to channel access latency levels of the plurality of communication links.

16. The apparatus of claim 10, wherein the processing system is further configured to cause the apparatus to:
obtain one or more stream classification service (SCS) messages to establish a quality of service (QoS) context for a communication flow associated with the priority client, wherein communicating via the priority communication link is in accordance with the QoS context.

17. The apparatus of claim 10, wherein the processing system is further configured to cause the apparatus to:
establish a quality of service (QoS) context for a communication flow associated with the priority client in accordance with a classification associated with the communication flow, the classification being in accordance with one or more data packets communicated via the communication flow.

18. The apparatus of claim 10, wherein the processing system is further configured to cause the apparatus to:
establish a quality of service (QoS) context for a communication flow associated with the priority client in accordance with one or more performance guarantees associated with an administration configuration.

19. The apparatus of claim 10, further comprises:
one or more antennas configure to communicate via the plurality of communication links, wherein the apparatus is configured as an access point (AP).

20. A method for wireless communication at a wireless node, comprising:
associating a first client with a plurality of communication links;
admitting the first client to a first communication link of the plurality of communication links, the admission being based at least in part on a quantity of idle clients on the first communication link being less than a threshold quantity of idle clients for the first communication link, wherein the threshold quantity of idle clients is based at least in part on a total quantity of idle clients associated with the plurality of communication links and a ratio of a residual link capacity of the first communication link with a total residual link capacity for the plurality of communication links; and
outputting a first frame for transmission to the first client via the first communication link, wherein the first frame indicates that the first client is allocated to the first communication link.
